(19) United States
(12) Patent Application Publication
(10) Pub. No.: US 2005/0185887 A1
(43) Pub. Date: Aug. 25, 2005

(54) Optical fiber collimator

(75) Inventors: Akito Takeuchi, Tokyo (JP); Ikuto Ohyama, Tokyo (JP)

Correspondence Address: CARSTENS YEE & CAHOON, LLP, P O BOX 802334, DALLAS, TX, 75380, US

(73) Assignee: NIPPON SHEET GLASS COMPANY, LIMITED, Tokyo (JP)

(21) Appl. No.: 11/028,752

(22) Filed: Jan. 4, 2005

(30) Foreign Application Priority Data
Jan. 5, 2004 (JP) 2004-000481

(51) Int. Cl. G02B 6/32

(52) U.S. Cl. 385/34

(57) ABSTRACT

An optical fiber collimator adaptable for light in a significantly expanded wavelength band. A fiber chip includes a single mode optical fiber held in a capillary. A gradient index rod lens and the fiber chip are retained in a glass sleeve. The rod lens, which is optically coupled to the fiber chip, converts light emitted from the optical fiber to a collimated beam. Alignment of the rod lens and the optical fiber is performed with light having a wavelength in a range of 1450 to 1600 nm so that the wavelength dependent loss of the optical fiber collimator is 0.15 dB or less in a wavelength range of 1250 to 1650 nm.

### CROSS-REFERENCE TO RELATED APPLICATIONS

This application is based upon and claims the benefit of priority from prior Japanese Patent Application No. 2004-000481, filed on Jan. 5, 2004, the entire contents of which are incorporated herein by reference.

### BACKGROUND OF THE INVENTION

The present invention relates to an optical fiber collimator.

An optical fiber collimator is an optical component that converges light emitted from an optical fiber with a lens to produce a collimated beam. Present optical communication uses light in the 1550 nm band. This light corresponds to the S band (1460 to 1530 nm) and the C band (1530 to 1565 nm) as defined by the International Telecommunication Union (ITU-T). Japanese Laid-Open Patent Publication No. 8-286076 describes a prior art example of an optical fiber collimator for use in optical communication. The characteristics of this optical fiber collimator will now be described.

(1) The coupling loss when opposing two optical fiber collimators, in which a single mode optical fiber (SMF) having a specific wavelength (2550 nm) is coupled to a lens, is minimum at a wavelength (1530 nm) that is shorter than the specific wavelength. From the specification of the above publication, it may be understood that the single mode optical fiber having the specific wavelength is an optical fiber having an anti-reflection (AR) coating applied thereto, with the AR coating adapted for light having such a wavelength.

(2) The focal position is adapted for light having a shorter wavelength (1530 nm) than the specific wavelength (1550 nm).

(3) The distance between the lens and the fiber is set so that it is shorter than the distance adapted for light having the specific wavelength (1550 nm).

The optical fiber collimator of the above publication is suitable only for light in the wavelength range of 1490 to 1580 nm (part of the S band and part of the C band). The technology of the above publication reduces coupling loss in the wavelength range of 1490 to 1580 nm. However, the bands defined by ITU-T are the O to L bands (1250 to 1650 nm). In such an ultra wide band, the optical fiber collimator of the above publication cannot obtain low coupling loss and low wavelength dependent loss.

This is because the lens-fiber alignment, such as a focal distance, of the collimator in the above publication is adapted for light in the wavelength band of 1490 to 1580 nm but not adapted for light in the wavelength band of 1250 to 1650 nm. Further, the anti-reflection coating has not been designed to be adapted for light in the ultra wide band.

### SUMMARY OF THE INVENTION

It is an object of the present invention to provide an optical fiber collimator adaptable for light in a significantly expanded wavelength band.

One aspect of the present invention is an optical fiber collimator provided with a fiber chip including a single mode optical fiber and a capillary for holding the optical fiber. A lens collimates light emitted from the optical fiber to produce a collimated beam. Wavelength dependent loss in a wavelength range of 1250 to 1650 nm is 0.2 dB or less.

Another aspect of the present invention is an optical fiber collimator provided with a fiber chip including a single mode optical fiber and a capillary for holding the optical fiber. A lens collimates light emitted from the optical fiber to produce a collimated beam. Insertion loss in a wavelength range of 1250 to 1650 nm is 0.2 dB or less.

A further aspect of the present invention is a method for manufacturing an optical fiber collimator adaptable for transmission of light having a wavelength in a range of 1250 to 1650 nm. The method includes preparing a single mode optical fiber, with an end surface to which an anti-reflection coating is applied, and a collimation lens, with an inclined end surface to which an anti-reflection coating is applied. The collimator lens has a lens length adapted for light of a specific wavelength, and each anti-reflection coating has a reflectance of 0.4% or less with respect to light in a wavelength range of 1250 to 1650 nm. The method further includes aligning the optical fiber and the collimation lens to optimize the distance between the end surface of the optical fiber and the inclined end surface of the collimation lens by using alignment light having a wavelength that is shorter than the specific wavelength so that wavelength dependent loss is 0.2 dB or less in a wavelength range of 1250 to 1650 nm. The method further includes fixing the optical fiber and the collimation lens with the optimized distance therebetween.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an optical fiber collimator according to a preferred embodiment of the present invention;

FIG. 2 is a graph showing the relationship between alignment wavelength and wavelength dependent loss;

FIG. 3 is a schematic diagram showing an alignment apparatus;

FIG. 4 is a schematic diagram showing a measurement apparatus for measuring wavelength dependency of insertion loss;

FIG. 5 is a graph showing calculation results of the wavelength dependency; and

FIG. 6 is a graph showing actual measurement results of wavelength dependency.

### DETAILED DESCRIPTION OF THE PREFERRED EMBODIMENTS

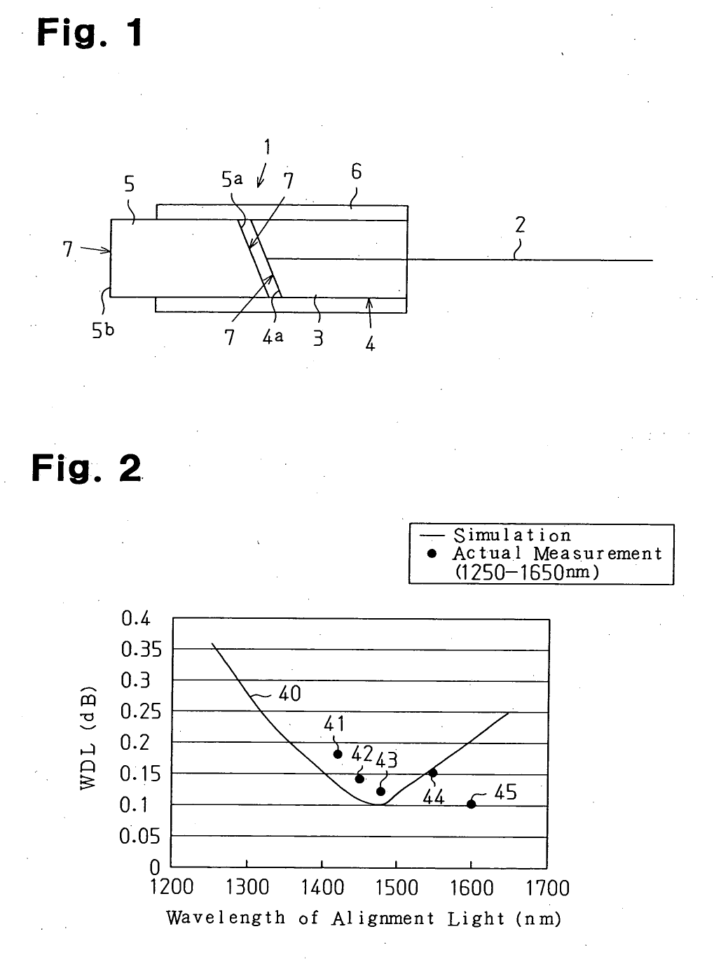

An optical fiber collimator 1 according to a preferred embodiment of the present invention will now be discussed with reference to FIG. 1.

As shown in FIG. 1, the optical fiber collimator 1 is formed by a fiber chip 4, which includes a single mode optical fiber 2 held in a capillary 3, a gradient index rod lens 5, and a glass sleeve 6. The rod lens 5, which functions as a collimation lens, collimates the light emitted from the optical fiber 2 to produce a collimated beam.

The rod lens 5 has, for example, a diameter of 1.8 mm, a center refractive index n₀ of 1.590 for light having the specific wavelength of 1550 nm, a refractive index constant √A of 0.3229, and a rod length Z of 0.23P. P is the wobbling cycle of a light beam that travels through the lens and is referred to as a pitch that is calculated from the equation of P=2π/√A. The lens length Z is the length between the two end surfaces 5a and 5b of the rod lens 5. When the rod lens 5 has an inclined end surface as shown in FIG. 1, the lens length Z is the distance from the intersection of the optical beam and the inclined end surface 5a to the other end surface 5b.

The rod lens 5 includes the first end surface 5a, which faces the optical fiber 2, and the second end surface 5b, which is on the opposite side of the first end surface 5a. The first end surface 5a is ground so that it is inclined at, for example, an angle of 8 degrees relative to a plane perpendicular to the optical axis of the rod lens 5. The second end surface 5b is ground so that it is perpendicular to the optical axis. An anti-reflection coating 7 is applied to the first end surface 5a of the rod lens 5. The anti-reflection coating 7 has, for example, a reflectance of 0.4% or less in the wavelength range of 1250 to 1650 nm.

The optical fiber 2 has a light emission surface and the capillary 3 has an end surface, which define an end surface 4a of the fiber chip 4. The end surface 4a is ground so that it is inclined at, for example, an angle of 8 degrees relative to a plane perpendicular to the optical axis of the rod lens 5. An anti-reflection coating 7 is applied to the end surface 4a of the fiber chip 4. The anti-reflection coating 7 has, for example, a reflectance of 0.4% or less in the wavelength range of 1250 to 1650 nm.

A method for manufacturing the optical fiber collimator 1 of FIG. 1 will now be described.

(First step) The optical fiber 2 is inserted in the fiber chip 4, which is made of glass and which has a fiber insertion hole (capillary 3) with an inner diameter of 1.8 mm. The optical fiber 2 is fixed to the capillary 3 with an adhesive agent to fabricate the fiber chip 4. The end surface 4a of the fiber chip 4 is ground to the predetermined angle (8 degrees). The anti-reflection coating 7 is applied to the inclined end surface 4a.

(Second step) The rod lens 5 is ground so that the first end surface 5a is inclined at the predetermined angle (8 degrees) and the second end surface 5b is vertical. The anti-reflection coating 7 is applied to the end surfaces 5a and 5b. The rod lens 5 is inserted in the glass sleeve 6 and fixed to the glass sleeve 6 with an adhesive agent.

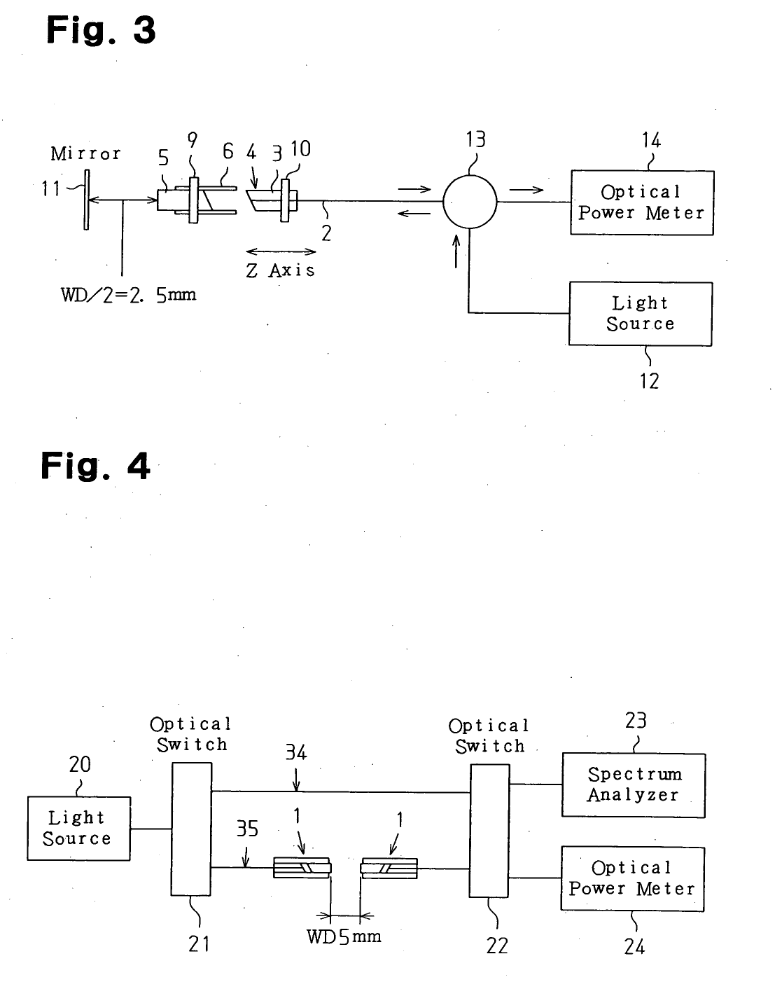

(Third step) As shown in FIG. 3, the glass sleeve 6 to which the rod lens 5 is fixed, and the fiber chip 4 are respectively secured to fixtures 9 and 10 on a precision stage (not shown). The relative positions of the fiber chip 4 and the rod lens 5 in the direction of the optical beam are adjusted while using light having a wavelength selected from the wavelength range of 1250 to 1650 nm, for example, light having a wavelength of 1450 nm. This determines the optimal distance between the end surfaces of the rod lens 5 and the optical fiber 2. The third step is a step for performing alignment in the optical axis direction. The selected wavelength is referred to as the alignment wavelength.

The alignment in the optical axis direction is performed using an alignment apparatus, which is shown in FIG. 3. The alignment apparatus includes a mirror 11 arranged at a position where the operation length WD is 5 mm. That is, the mirror 11 is arranged at a position separated from the second end surface 5b of the rod lens 5 by 2.5 mm (WD/2).

When the wavelength selected from the wavelength range of 1250 to 1650 nm is 1450 nm, a light source 12 emits alignment light having an alignment wavelength of 1450 nm. The light enters the optical fiber 2 via an optical circulator 13 and travels through the rod lens 5 to be reflected by the mirror 11. This returns the light to the rod lens 5, the optical fiber 2, and then the optical circulator 13. The optical circulator 13 sends the light to an optical power meter 14, which measures the intensity of the received light. The relative positions of the fiber chip 4 and the rod lens 5 in the optical axis (Z axis) direction is adjusted so that the light intensity becomes maximum.

(Fourth step) After the distance between the end surfaces of the rod lens 5 and the optical fiber 2 is optimized, the fiber chip 4 is fixed to the glass sleeve 6 with an adhesive agent. This completes the optical fiber collimator 1.

The wavelength dependency of the coupling loss (insertion loss) of light will now be discussed.

The coupling loss (insertion loss) of light that travels through two optical fiber collimators 1 arranged facing towards each other was calculated (simulated) for various wavelengths. In the calculation, loss caused by the materials of the anti-reflection coating 7, the optical fiber 2, and the rod lens 5 was not taken into consideration. The distance between the end surfaces of the rod lens 5 and the optical fiber 2 in the subject optical fiber collimators 1 was optimized using light having an alignment wavelength selected from the wavelength range of 1250 nm to 1650 nm.

The graph of FIG. 5 shows some of the calculation results. Curves a, b, c, d, e, f, g, h, i, j, k, and l respectively show the wavelength dependence of the insertion loss for alignment wavelengths of 1250, 1280, 1310, 1350, 1400, 1420, 1450, 1480, 1500, 1550, 1580, and 1600 nm.

The level of the wavelength dependency of the insertion loss was evaluated based on the wavelength dependent loss (WDL). The wavelength dependent loss (WDL) is the difference between the maximum and minimum insertion loss values (dB) in a predetermined wavelength range.

Table 1 shows the calculated values (dB) of the wavelength dependent loss (WDL) in the wavelength range of 1250 to 1650 nm for the alignment wavelengths of 1250, 1280, 1310, 1350, 1400, 1420, 1450, 1480, 1500, 1550, 1580, 1600, 1620, and 1650 nm.

Table 1 shows the calculated values (dB) of the wavelength dependent loss (WDL) for the alignment wavelengths of 1620 and 1650 nm, which are not shown in FIG. 5.

TABLE 1
Relationship Between Wavelength Dependency Loss (WDL) of
Collimator and Alignment Wavelength

| Alignment | Calculated WDL | |
|---|---|---|
| Wavelength (nm) | (dB) | Actual WDL (dB) |
| 1250 | 0.36 | — |
| 1280 | 0.31 | — |
| 1310 | 0.26 | — |
| 1350 | 0.20 | — |
| 1400 | 0.15 | — |
| 1420 | 0.15 | 0.18 |
| 1450 | 0.12 | 0.14 |
| 1480 | 0.10 | 0.12 |
| 1500 | 0.12 | — |
| 1550 | 0.16 | 0.15 |
| 1580 | 0.18 | — |
| 1600 | 0.20 | 0.10 |
| 1620 | 0.22 | — |
| 1650 | 0.25 | — |

As apparent from the calculated values, the wavelength dependent loss for the wavelength range of 1250 to 1650 nm was most satisfactory for the alignment wavelength of 1480 nm for which wavelength dependent loss was 0.10 dB. The wavelength dependent loss was 0.16 dB or less when the alignment wavelength was in the wavelength range of 1400 to 1550 nm. The wavelength dependent loss becomes unsatisfactory for wavelengths that are less than or greater than the wavelength range of 1400 to 1550 nm.

The actual coupling loss (insertion loss) of light that travels through two optical fiber collimators 1 arranged facing towards each other was measured for various wavelengths. As shown in FIG. 4, when measuring the wavelength dependency of insertion loss, the operation length WD was 5 mm for two opposing optical fiber collimators 1, for each of which distance between the end surfaces of the rod lens 5 and the optical fiber 2 was optimized with the light of each alignment wavelength.

A measurement apparatus as schematically shown in FIG. 4 will now be described. A light source 20, two optical switches 21 and 22, an optical spectrum analyzer 23, and an optical power meter 24 are optically coupled to one another. Optical paths 34 and 35 extend between the two optical switches 21 and 22. The two optical fiber collimators 2 separated from each other by the operation length WD (5 mm) was arranged in the optical path 34. The optical paths 34 and 35 are formed by optical fibers. The light source 20 is a tunable laser light source that enables the wavelength of the emitted light to be varied within the wavelength range of, for example, 1250 to 1653 nm.

When the two optical switches 21 and 22 are switched to a first position, the emitted light of the light source 20 does not travel through the fiber collimators 1 and travels through the optical path 34 and to the optical spectrum analyzer 23. In this case, the optical spectrum analyzer 23 measures the optical spectrum of the light source 20. The measurement range of the optical spectrum is 1250 to 1650 nm. When the two optical switches 21 and 22 are switched to a second position, the emitted light of the light source 20 travels through the optical path 35, which includes the fiber collimators 1, and to the optical power meter 24. The optical power meter 24 measures the intensity of the received light. The emitted light of which intensity is measured is in the wavelength range of 1250 to 1650 nm. The wavelength dependency of the insertion loss for the two optical fiber collimators 1 are measured based on the optical spectrum of the light source 20 measured by the optical spectrum analyzer 23 and the intensity of the emitted light measured by the optical power meter 24.

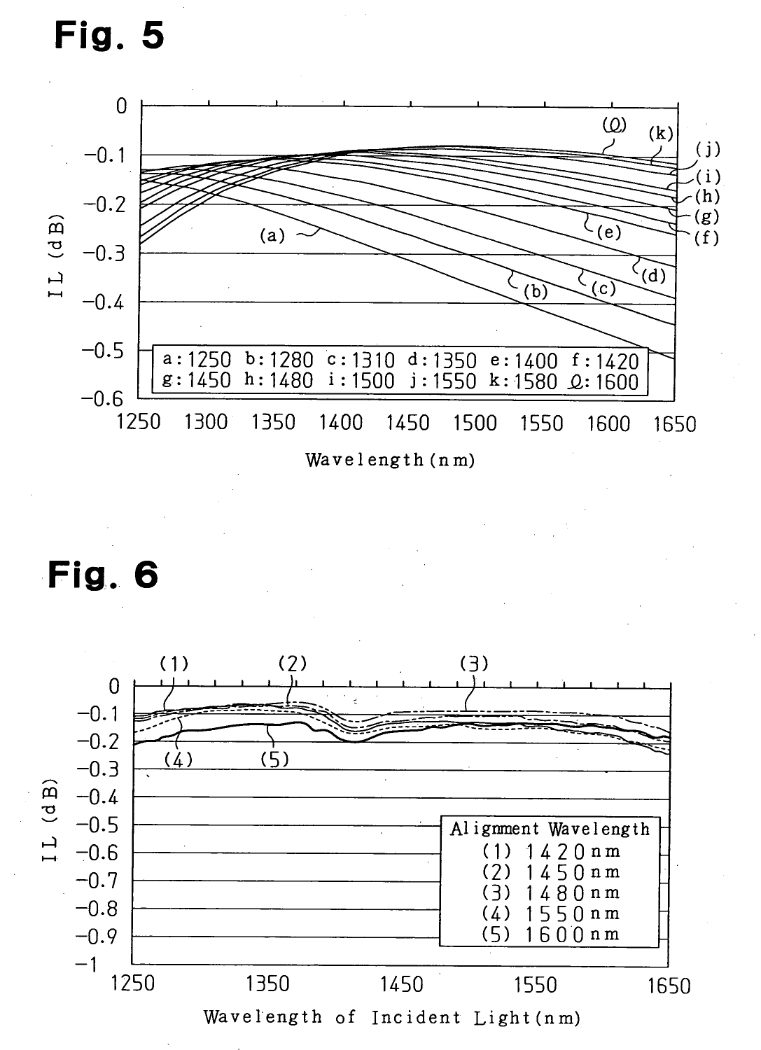

FIG. 6 shows the insertion loss for two optical fiber collimators 1, which have been aligned with various alignment wavelengths. Curves (1), (2), (3), (4), and (5) respectively show the insertion loss for the alignment wavelengths of 1420, 1450, 1480, 1550, and 1600 nm. Table 1 shows the actually measurement values (dB) of the wavelength dependent loss (WDL) for the alignment wavelengths of 1420, 1450, 1480, 1550, and 1600 nm.

As apparent from the actual measurement values of table 1, the wavelength dependent loss in the wavelength range of 1450 to 1650 nm was most satisfactory in the alignment wavelength of 1600 nm for which wavelength dependent loss was 0.10 dB (refer to FIG. 2).

From the results of FIG. 2, it is apparent that for the optical fiber collimators 1 aligned with a wavelength in the wavelength range of 1450 to 1600 nm, the wavelength dependent loss (WDL) in the wavelength range of 1250 to 1650 nm was 0.15 dB or less.

FIG. 2 shows the relationship between the alignment wavelength and the wavelength dependent loss (WDL) in the wavelength range of 1250 to 1650 nm. In FIG. 2, curve 40, which was plotted along the calculated values of table 1 obtained from the simulation result of FIG. 5, shows change in the wavelength dependent loss (WDL) in accordance with the alignment wavelength. In FIG. 2, the dots 41 to 45 respectively indicate the actual measurement values of the wavelength dependent loss (WDL) for light of alignment wavelengths 1420, 1450, 1480, 1550, and 1600 nm.

From the calculated values and actual measurement values shown in the graph of FIG. 2 and table 1, it is apparent that the calculated values and actual measurement values of the wavelength dependent loss (WDL) were substantially matched when the alignment wavelength was in the wavelength range of 1420 to 1600 nm. It is also apparent that the wavelength dependent loss (WDL) was 0.25 dB or less in the wavelength range of 1250 to 1650 nm when the alignment wavelength was selected from the wavelength range of 1420 to 1600 nm.

The preferred embodiment has the advantages described below.

From the calculated values and actual measurement values shown in the graph of FIG. 2 and table 1, it is apparent that when the optical fiber collimator 1 is aligned using a wavelength in the wavelength range of 1350 to 1600 nm, the wavelength dependent loss (WDL) is 0.20 dB or less (in the range of 0.2 dB to 0.10 dB) in the wavelength range of 1250 to 1650 nm. Thus, a low wavelength dependent loss (WDL) of 0.20 dB or less is obtained in the wide wavelength range of 1250 to 1650 nm. Accordingly, the optical fiber collimator 1 may be used for light in a wide wavelength band.

From the actual measurement values shown in FIG. 2 and table 1, it is apparent that when the optical fiber collimator 1 is aligned using a wavelength in the wavelength range of 1450 to 1600 nm, the wavelength dependent loss (WDL) is 0.15 dB or less (in the range of 0.15 dB to 0.10 dB) in the wavelength range of 1250 to 1650 nm. Accordingly, the optical fiber collimator 1 may be used for light in a wide wavelength band.

From the actual measurement results shown in FIG. 6, it is apparent that when the optical fiber collimator 1 is aligned using a wavelength in the wavelength range of 1420 to 1600 nm, the insertion loss (IL) is 0.20 dB or less in the wavelength range of 1250 to 1650 nm. Thus, a low insertion loss (IL) of 0.2 dB or less (in the range of 0.2 dB to 0.1 dB) is obtained in the wide wavelength range of 1250 to 1650 nm. Accordingly, the optical fiber collimator 1 may be used for light in a wide wavelength band.

The anti-reflection coating 7 applied to the first and second end surfaces 5a and 5b of the rod lens 5 and to the end surface 4a of the fiber chip 4 have a reflectance of 0.4% or less in the wavelength range of 1250 to 1650 nm. This realizes an optical fiber collimator 1 having a reduced reflectance with respect to returning light in the wide wavelength range of 1250 1650 nm.

The optical fiber collimator 1, which includes the rod lens 5, is adaptable for light in a significantly expanded wavelength band.

As described above, the present invention provides an optical fiber collimator that is adaptable for light in a significantly expanded wavelength band. Such wide band optical fiber collimator may be used in the future in wavelength division multiplexing technology, such as coarse wavelength division multiplexing (CWDM), and is especially useful for light with multiple wavelengths.

It should be apparent to those skilled in the art that the present invention may be embodied in many other specific forms without departing from the spirit or scope of the invention. Particularly, it should be understood that the present invention may be embodied in the following forms.

Instead of the gradient index rod lens 5, a spherical lens or an aspherical lens may be used.

The specification of the rod lens 5 (the diameter, center refractive index n₀ with respect to light having the specific wavelength, the refractive index constant √A, and the rod length Z) may be changed.

The operation length WD of the optical fiber collimator 1 is not limited to 5 mm and may be in the range of, for example, 0 to 70 mm.

The inclination angle of the first end surface 5a of the rod lens 5 and the end surface 4a of the fiber chip 4 may be any angle other than 8 degrees.

Instead of the glass sleeve 6, a metal sleeve may be used.

The present examples and embodiments are to be considered as illustrative and not restrictive, and the invention is not to be limited to the details given herein, but may be modified within the scope and equivalence of the appended claims.

1. An optical fiber collimator comprising:
a fiber chip including a single mode optical fiber and a capillary for holding the optical fiber; and
a lens for collimating light emitted from the optical fiber to produce a collimated beam, wherein wavelength dependent loss in a wavelength range of 1250 to 1650 nm is 0.2 dB or less.

2. The optical fiber collimator according to claim 1, further comprising:
an anti-reflection coating applied to an end surface of the lens and to an end surface of the fiber chip, wherein the anti-reflection coating has a reflectance of 0.4% or less with respect to light in the wavelength range of 1250 to 1650 nm.

3. The optical fiber collimator according to claim 1, wherein the lens is a gradient index rod lens.

4. The optical fiber collimator according to claim 1, wherein the optical fiber and the lens are aligned with a wavelength in a wavelength range of 1350 to 1600 nm.

5. The optical fiber collimator according to claim 1, wherein the wavelength dependent loss in the wavelength range of 1250 to 1650 nm is 0.15 dB or less.

6. The optical fiber collimator according to claim 5, further comprising:
an anti-reflection coating applied to an end surface of the lens and to an end surface of the fiber chip, wherein the anti-reflection coating has a reflectance of 0.4% or less with respect to light in the wavelength range of 1250 to 1650 nm.

7. The optical fiber collimator according to claim 5, wherein the lens is a gradient index rod lens.

8. The optical fiber collimator according to claim 5, wherein the optical fiber and the lens are aligned with a wavelength in a wavelength range of 1450 to 1600 nm.

9. An optical fiber collimator comprising:
a fiber chip including a single mode optical fiber and a capillary for holding the optical fiber; and
a lens for collimating light emitted from the optical fiber to produce a collimated beam, wherein insertion loss in a wavelength range of 1250 to 1650 nm is 0.2 dB or less.

10. The optical fiber collimator according to claim 9, further comprising:
an anti-reflection coating applied to an end surface of the lens and to an end surface of the fiber chip, wherein the anti-reflection coating has a reflectance of 0.4% or less with respect to light in the wavelength range of 1250 to 1650 nm.

11. The optical fiber collimator according to claim 9, wherein the lens is a gradient index rod lens.

12. A method for manufacturing an optical fiber collimator adaptable for transmission of light having a wavelength in a range of 1250 to 1650 nm, the method comprising:
preparing a single mode optical fiber, including an end surface to which an anti-reflection coating is applied, and a collimation lens, including an inclined end surface to which an anti-reflection coating is applied, the collimator lens having a lens length adapted for light of a specific wavelength, and each anti-reflection coating having a reflectance of 0.4% or less with respect to light in a wavelength range of 1250 to 1650 nm;
selecting alignment light having a wavelength that is shorter than the specific wavelength;
aligning the optical fiber and the collimation lens to optimize the distance between the end surface of the optical fiber and the inclined end surface of the collimation lens by using the alignment light so that wavelength dependent loss is 0.2 dB or less in a wavelength range of 1250 to 1650 nm; and
fixing the optical fiber and the collimation lens with the optimized distance therebetween.

13. The method according to claim 12, wherein said aligning includes adjusting the distance so that insertion loss is 0.2 dB or less in a wavelength range of 1250 to 1650 nm.

14. The method according to claim 12, wherein the specific wavelength is 1550 nm, and the wavelength of the alignment light is in a range of 1450 to 1600 nm.

15. The method according to claim 12, wherein the collimation lens is a gradient index rod lens.
